(19) United States
(12) Patent Application Publication
(10) Pub. No.: US 2010/0217961 A1
(43) Pub. Date: Aug. 26, 2010

(54) PROCESSOR SYSTEM EXECUTING PIPELINE PROCESSING AND PIPELINE PROCESSING METHOD

(76) Inventor: Soichiro HOSODA, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/610,537

(22) Filed: Nov. 2, 2009

(30) Foreign Application Priority Data
Feb. 23, 2009 (JP) 2009-039812

(51) Int. Cl. G06F 9/38

(52) U.S. Cl. 712/234; 712/E09.045

(57) ABSTRACT

A processor system includes a plurality of pipeline stages, a controller, and a transfer path. The plurality of pipeline stages is subjected to processing. The controller determines whether or not each of the executable instructions to be processed in the pipeline stages requires processing in a succeeding pipeline stage. The transfer path, if the controller determines the executable instruction does not require the processing in the succeeding pipeline stage, skips the pipeline stage including the unnecessary processing.

### CROSS-REFERENCE TO RELATED APPLICATIONS

This application is based upon and claims the benefit of priority from prior Japanese Patent Application No. 2009-039812, filed Feb. 23, 2009, the entire contents of which are incorporated herein by reference.

### BACKGROUND OF THE INVENTION

1. Field of the Invention

The present invention relates to a processor system executing pipeline processing and a pipeline processing method.

2. Description of the Related Art

In conventional processor systems executing pipeline processing, executable instructions pass through all pipeline stages. Each executable instruction passes through the pipeline stages even if any of the pipeline stages is unnecessary for the instruction. Thus, even when an executable instruction different from a predetermined one passes through a certain pipeline stage (the executable instruction need not pass through the pipeline stage), an arithmetic unit, a memory, and various pieces of hardware in the stage need to be uselessly toggled (operated). Thus, disadvantageously, extra power is consumed.

For a technique related to pipeline operations, proposals have been made in, for example, Jpn. Pat. Appln. KOKAI Publication No. 3-269728 and Jpn. Pat. Appln. KOKAI Publication No. 2008-158810. The proposals relate to equipment providing a skip function.

However, in connection with this well-known technique, for example, Jpn. Pat. Appln. KOKAI Publication No. 3-269728 uses a skip instruction to controllably determine whether or not to execute the succeeding instruction depending on whether or not a relevant condition (branch) holds true. Furthermore, Jpn. Pat. Appln. KOKAI Publication No. 2008-158810 uses an instruction with the skip function to store the result of a calculation by an execution unit in a flag register. Then, the calculation result is compared with skip condition bits. Thus, conditioned instructions can be executed without the need for the conditioned instructions.

Thus, all the above-described methods need a special instruction in order to reduce toggling required when an instruction passes through the stage through which the instruction otherwise need not pass, thus reducing extra power consumption.

### BRIEF SUMMARY OF THE INVENTION

A processor system according to an aspect of the invention includes,

a plurality of pipeline stages in which an instruction sequence comprising a plurality of executable instructions is subjected to processing;

a controller determining whether or not each of the executable instructions to be processed in the pipeline stages requires processing in a succeeding pipeline stage; and

a transfer path which, if the controller determines that the executable instruction does not require the processing in the succeeding pipeline stage, skips the pipeline stage including the unnecessary processing.

A method for subjecting an executable instruction to pipeline processing according to an aspect of the invention includes, determining that an i-th (i is a natural number greater than or equal to 1) executable instruction does not use hardware resources in a j-th (j is a natural number greater than or equal to 1) pipeline stage but uses hardware resources in a (j+1)-th pipeline stage;

determining whether or not a (i−1)-th executable instruction uses any of those of the hardware resources in the (j+1)-th pipeline stage which are to be used by the i-th executable instruction; and

if the (i−1)-th executable instruction is determined not to use any of those of the hardware resources in the (j+1)-th pipeline stages which are to be used by the i-th executable instruction, allowing the i-th executable instruction to skip processing in the j-th pipeline stage.

### BRIEF DESCRIPTION OF THE SEVERAL VIEWS OF THE DRAWING

FIG. 1 to FIG. 13 are block diagrams showing an example of the configuration of a processor system (pipeline processor) according to an embodiment of the present invention;

FIG. 14 is a flowchart showing the operation of the processor system according to the embodiment; and

FIG. 15 to FIG. 17 are block diagrams of the processor system according to the embodiment, showing that the processor system operates according to the value of a program counter.

### DETAILED DESCRIPTION OF THE INVENTION

An embodiment of the present invention will be described in detail with reference to the drawings. However, it should be noted that the drawings are schematic and the dimensions and scales in the drawings are different from the actual ones. Furthermore, of course, the drawings partly include different dimensional relationships and/or different scales. In particular, several examples described below illustrate apparatuses and methods for embodying the technical concepts of the present invention. The technical concepts of the present invention are not specified by the shapes, structures, or arrangements of components. Various changes may be made to the technical concepts of the present invention without departing from the spirit of the present invention.

### [Configuration]

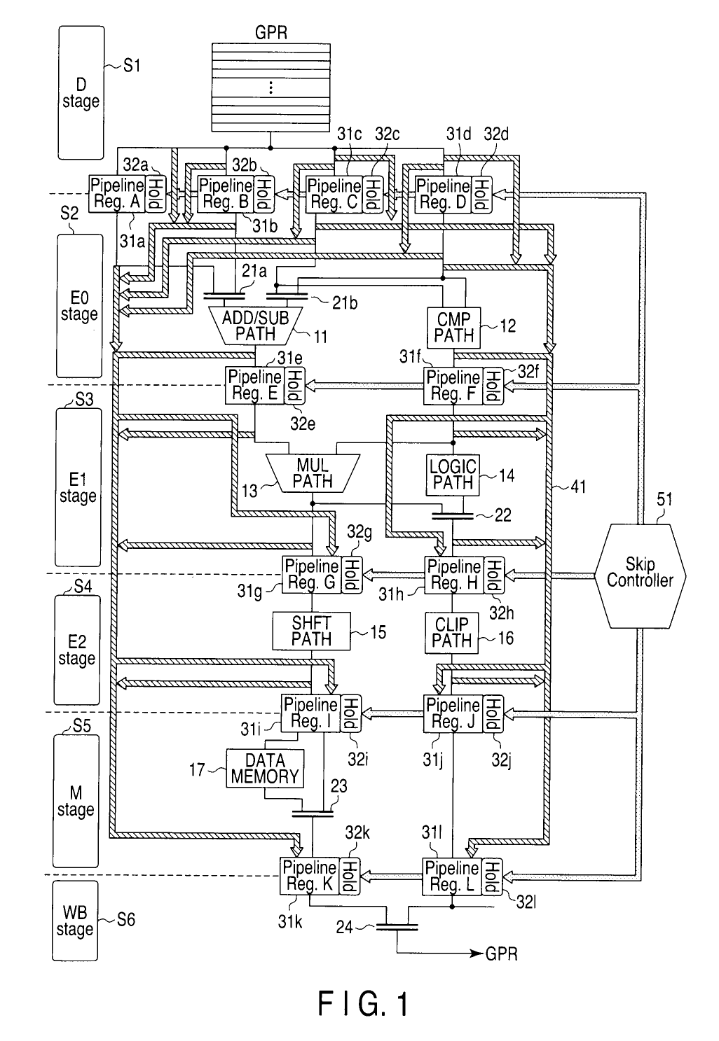

FIG. 1 is a block diagram showing an example of the configuration of a processor system according to an embodiment of the present invention. In the embodiment, as an in-order processor system executing pipeline processing, a pipeline processor including a stage skip function will be described. FIG. 1 shows a pipeline configuration from a decode stage (corresponding to a read stage for a general-purpose register GPR) to a writeback stage of the pipeline processor (a part of the stage configuration corresponding to operations before instruction fetch is omitted from the drawings since such a part has no direct influence on the operation of the present embodiment).

As shown in FIG. 1, the pipeline processor includes the first to the sixth pipeline stage. The first stage is a decode (D) stage including a general-purpose register GPR. Arithmetic data and the like are stored in the general-purpose register GPR.

The second (E0) stage S2 includes an ADD/SUB arithmetic unit 11 and a CMP arithmetic unit 12 which execute required processing in response to executable instructions. Selectors 21a and 21b are connected to an input stage of the ADD/SUB arithmetic unit 11. The ADD/SUB arithmetic unit 11, for example, executes an addition and/or a subtraction on an output from the selector 21a and an output from the selector 21b. The CMP arithmetic unit 12, for example, compares the output from the pipeline register 31c (Reg. C) with the output from the pipeline register 31d (Reg. d).

The third (E1) stage S3 includes a MUL arithmetic unit 13 and a LOGIC arithmetic unit 14 which execute required processing in response to corresponding executable instructions. A selector 22 is connected to an output of the MUL arithmetic unit 13 and to an output stage of the LOGIC arithmetic unit 14. The MUL arithmetic unit 13 multiplies a plurality of inputs together. The LOGIC arithmetic unit 14 executes a logical calculation on an input signal. The selector 22 can select either an output from the MUL arithmetic unit 13 or an output from the LOGIC arithmetic unit 14.

The fourth (E2) stage S4 includes a SHFT arithmetic unit 15 and a CLIP arithmetic unit 16 which execute required processing in response to corresponding executable instructions. The SHFT arithmetic unit 15 executes a shift calculation on an input signal. The CLIP arithmetic unit 16 executes a clip calculation on an input signal.

Each of the arithmetic units 11 to 16 has a PATH function of passing an instruction through the corresponding processing.

The fifth stage S5 is a memory (M) stage including a data memory 17 executing required processing on input data in response to an executable instruction. A selector 23 is connected to an output stage of the data memory 17. The selector 23 selects either the input data or an output from the data memory 17.

The sixth stage S6 is a writeback (WB) stage including a selector 24. The selector 24 is connected to the general-purpose register GPR. A signal selected by the selector 24 is written to the general-purpose register GPR.

Four pipeline registers 31a, 31b, 31c, and 31d are provided between the first stage S1 and the second stage S2. Pipeline registers 31a and 31b have an input connected to the general-purpose register GPR and an output connected to the selector 21a. That is, the selector 21a can select either an output from pipeline register 31a or an output from pipeline register 31b.

Pipeline registers 31c and 31d have an input connected to the output of the general-purpose register GPR and an output connected to an input of the selector 21b and to an input of the CMP arithmetic unit 12. That is, the selector 21b can select either the output from pipeline register 31c or the output from pipeline register 31d. The CMP arithmetic unit 12 can compare the output from pipeline register 31c with the output from pipeline register 31d.

Two pipeline registers 31e and 31f are provided between the second stage S2 and the third stage S3. Pipeline register 31e has an input connected to an output of the ADD/SUB arithmetic unit 11 and an output connected to an input of the MUL arithmetic unit 13. Pipeline register 31f has an input connected to an output of the CMP arithmetic unit 12 and an output connected to the input of the MUL arithmetic unit 13 and an input of the LOGIC arithmetic unit 14.

That is, the MUL arithmetic unit 13 can calculate an output from pipeline register 31e and an output from pipeline register 31f. Furthermore, the LOGIC arithmetic unit 14 can execute a logical calculation on the output from pipeline register 31f.

Two pipeline registers 31g and 31h are provided between the third stage S3 and the fourth stage S4. Pipeline register 31g has an input connected to an output of the MUL arithmetic unit 13 and an output connected to an input of the SHFT arithmetic unit 15. Pipeline register 31h has an input connected to an output of the selector 22 and an output connected to an input of CLIP arithmetic unit 16.

That is, the SHFT arithmetic unit 15 can perform calculations for pipeline register 31g. Furthermore, the CLIP arithmetic unit 16 can logically calculate an output from pipeline register 31h.

Two pipeline registers 31i and 31j are provided between the fourth stage S4 and the fifth stage S5. Pipeline register 31i has an input connected to an output of the SHFT arithmetic unit 15 and an output connected to an input of the data memory 17 and to an input of the SHFT arithmetic unit 15. Pipeline register 31j has an input connected to an output of the CLIP arithmetic unit 16 and an output connected to pipeline register 31l.

That is, the data memory 17 holds an output from pipeline register 31i. Furthermore, the selector 23 can select either an output from pipeline register 31i or an output from the data memory 17.

Two pipeline registers 31k and 31l are provided between the fifth stage S5 and the sixth stage S6. Pipeline register 31k has an input connected to an output of the selector 23 and an output connected to an input of the selector 24. Pipeline register 31l has an input connected to an output of pipeline register 31j and an output connected to an input of the selector 24.

That is, the selector 24 can select either an output from pipeline register 31k or an output from pipeline register 31l.

Pipeline registers 31a to 31l hold interstage information (for example, arithmetic data from the general-purpose register GPR and the results of calculations in stages S2, S3, S4, and S5). Pipeline registers 31a to 31l include respective hold circuits 32a to 32l. The hold circuits 32a to 32l hold, during a specified cycle, the interstage information held in pipeline registers 31a to 31l.

Furthermore, the pipeline processor includes a skip path (shown by a shaded arrow in FIG. 1) 41 and a skip controller 51.

The skip path 41 allows skipping (non-passage) of a skippable pipeline stage in response to an executable instruction under the control of a skip controller 51. The skip path 41 connects, for example, each pipeline stage to a pipeline register located at least one stage after the pipeline stage. In the present embodiment, the skip path 41 may include the following.
A path along which an output from the general-purpose register GPR to any of pipeline registers 31a to 31d, an output from any of pipeline registers 31a to 31e, or an output from the ADD/SUB arithmetic unit 11 is allowed to skip to pipeline register 31g, 31i, or 31k,
A path along which the output from the general-purpose register GPR to any of pipeline registers 31a to 31d, the output from any of pipeline registers 31a to 31e, the output from the ADD/SUB arithmetic unit 11, or an output from the MUL arithmetic unit 13 is allowed to skip to pipeline register 31i or 31k,
A path along which the output from the general-purpose register GPR to any of pipeline registers 31a to 31d, the output from any of pipeline registers 31a to 31e, the output from the ADD/SUB arithmetic unit 11, the output from the MUL arithmetic unit 13, or an output from the SHFT arithmetic unit 15 is allowed to skip to pipeline register 31k,
A path along which the output from the general-purpose register GPR to pipeline register 31c or 31d, the output from pipeline register 31c or 31d, or an output from the CMP arithmetic unit 12 is allowed to skip to pipeline register 31h, 31j, or 31l,
A path along which the output from the general-purpose register GPR to pipeline register 31c or 31d, the output from pipeline register 31c, 31d, or 31f, or an output from the selector 22 is allowed to skip to pipeline register 31j or 31l,
A path along which an output from the general-purpose register GPR to pipeline register 31c or 31d, an output from pipeline register 31c, 31d, or 31f, an output from the CMP arithmetic unit 12, an output from the pipeline register 31f, an output from the selector 22, or an output from the CLIP arithmetic unit 16 is allowed to skip to pipeline register 31l.

The skip controller 51 determines a skippable pipeline stage based on executable instructions. According to the result of the determination, the skip controller 51 controls pipeline registers 31a to 31l, the hold circuits 32a to 32l, and the skip circuit 41.

### [Operations]

Now, the main operation of the pipeline processor shown in FIG. 1 will be described. The pipeline processor according to the present embodiment can perform, for example, four operations shown below. Each of the operations will be described below. In the description, the arithmetic units, pipeline registers, hold circuits, and skip paths which are identifiably shown in the figures are actually used (the components operate while consuming power in connection with toggling).

(1) Single-stage skip operation

(2) Double-stage skip operation

(3) Skip after hold operation

(4) Skip with priority operation

Skip operations for at least two stages are similar to the double-stage skip operation in (2) and will thus not be described in detail.

### (1) Single-Stage Skip Operation

The single-stage skip operation allows skipping of one succeeding pipeline stage in the pipeline processor configured as described above. In the present example, execution of an instruction sequence 1 in Table 1 shown below will be described by way of example.

TABLE 1
Instruction sequence

| PC | CODE |
|---|---|
| n | CLIP[MUL{ADD(A, C), D}] |
| n + 1 | SHFT{ADD(B, C)} |

Here, in the instruction sequence 1, the operation code of an instruction ID [n] (hereinafter referred to as an executable instruction [PC: n]) in a program counter (PC) can be interpreted as follows.
“In the second (E0) stage S2, the hold value of pipeline register 31a (Reg. A) and the hold value of pipeline register 31c (Reg. C) are added together, and the hold value of pipeline register 31d (Reg. D) is passed through the second stage”; then
“In the third (E1) stage S3, the hold value of pipeline register 31e (Reg. E) and the hold value of pipeline register 31f (Reg. F) are multiplied together”; and then
“In the fourth (E2) stage S4, the hold value of pipeline register 31h (Reg. H) is clipped”.

Furthermore, the operation code of an instruction ID [n+1] (hereinafter referred to as an executable instruction [PC: n+1]) in the program counter can be interpreted as follows.
“In the second stage S2, the hold value of pipeline register 31b (Reg. B) and the hold value of pipeline register 31c (Reg. C) are added together”; then
“In the third stage S3, the hold value of pipeline register 31e (Reg. E) is passed through stage S3”; and then
“In the fourth stage S4, the hold value of pipeline register 31g (Reg. G) is shifted”.

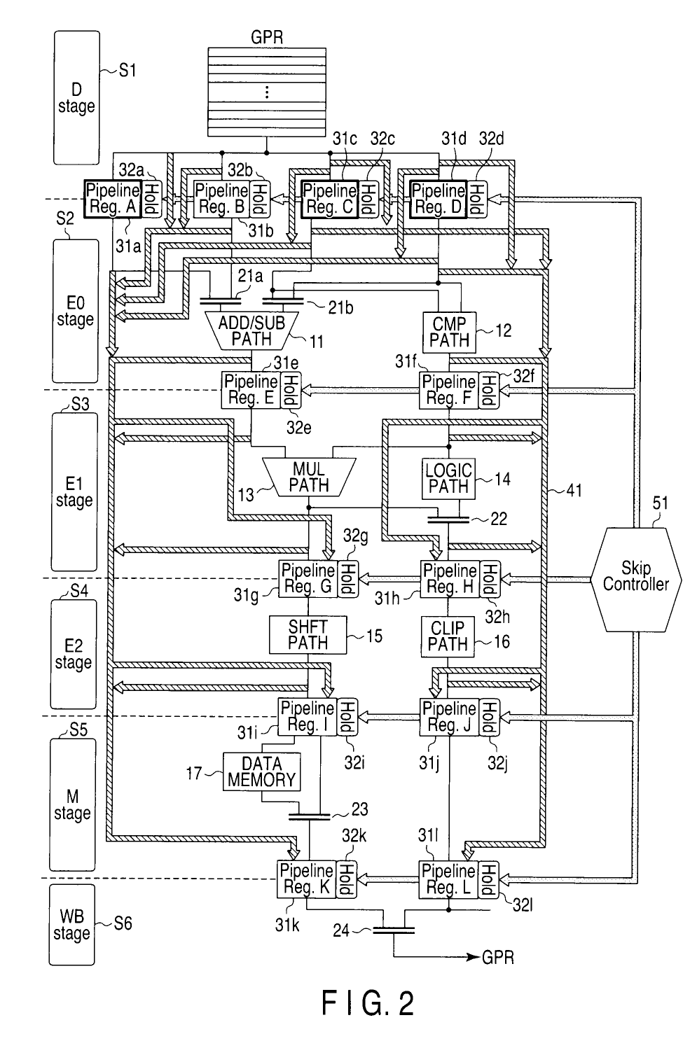

In the pipeline processor, first, the executable instruction [PC: n] (CLIP [MUL {ADD (A, C), D}]) with the smaller PC value is executed. That is, in the first cycle, since the executable instruction [PC: n] is present in the first stage S1 (the instruction is present in pipeline registers 31a, 31c, and 31d), each of pipeline registers 31a, 31c, and 31d holds the output from the pipeline general-purpose register GPR as interstage information. This is shown in the block diagram of the processor in FIG. 2. In FIG. 2, highlighted blocks are to be processed.

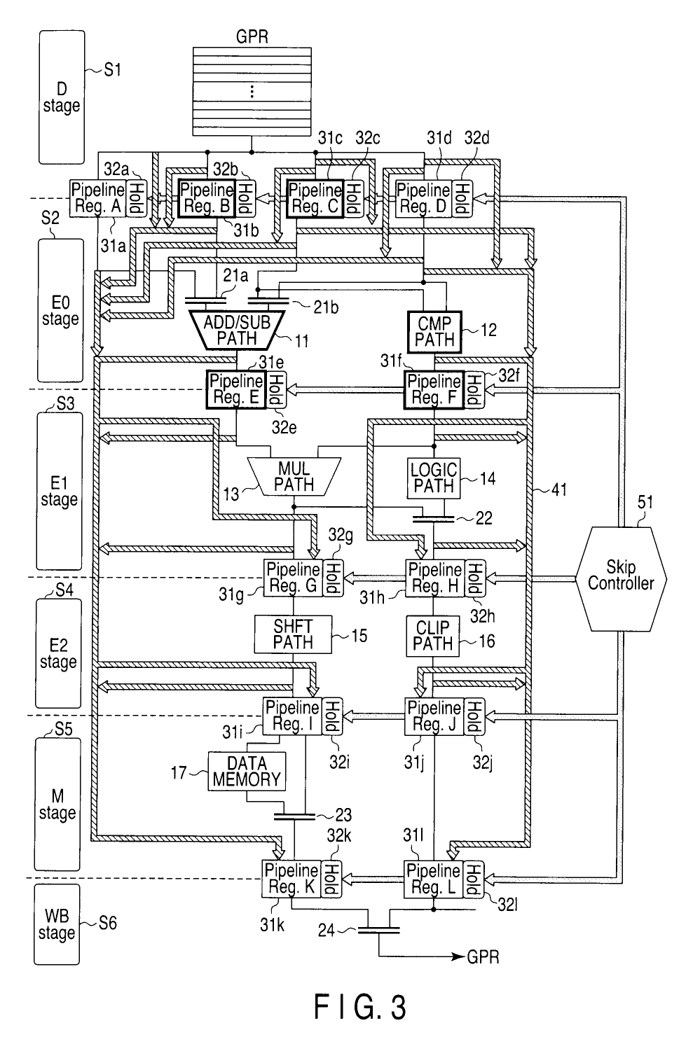

In the next cycle, since the executable instruction [PC: n] is present in the second stage S2, the ADD/SUB arithmetic unit 11 and the PATH function of the CMP arithmetic unit 12 are toggled in the second stage S2. Further, pipeline register 31e holds the result of the addition (Reg. A+Reg. C) and pipeline register 31f holds the hold value of pipeline register 31d (the through result from pipeline register 31d). This is shown in the block diagram of the processor in FIG. 3. Since the executable instruction [PC: n+1] is present in the first stage S1, each of pipeline registers 31b and 31c holds the output from the pipeline general-purpose register GPR as interstage information in the first stage S1, as shown in FIG. 3.

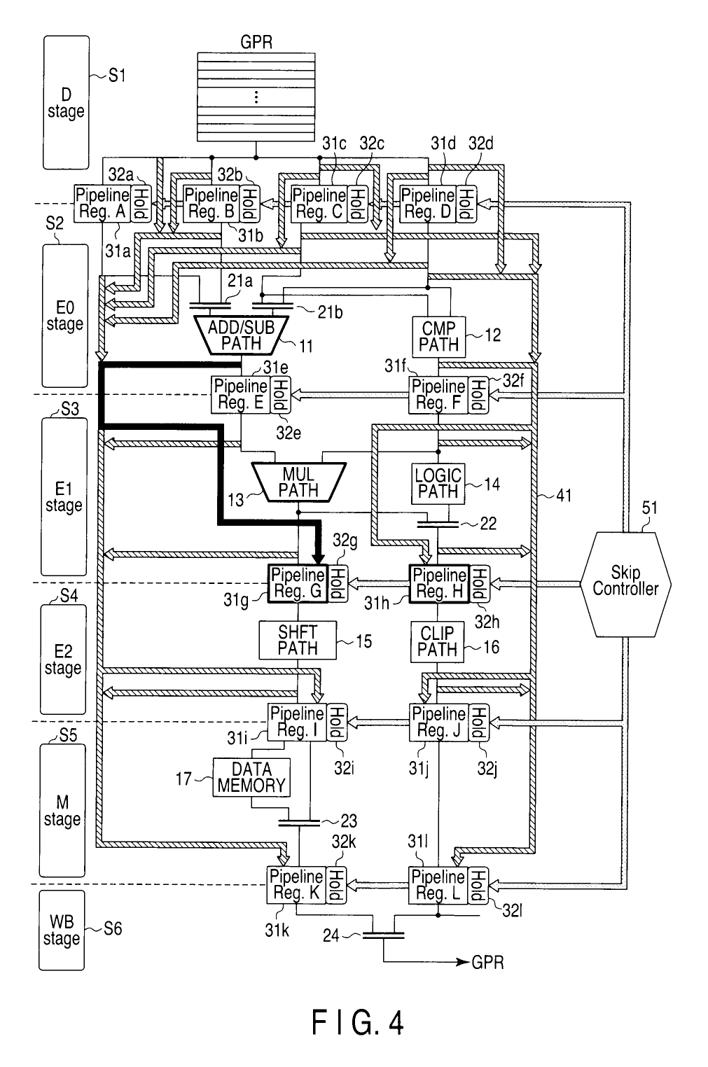

In the next cycle, since the executable instruction [PC: n] is present in the third stage S3, the MUL arithmetic unit 13 is toggled, with the result (Reg. E×Reg. F) held in pipeline register 31h, in the third stage S3. This is shown in the block diagram of the processor in FIG. 4. Furthermore, since the executable instruction [PC: n+1] is present in the second stage S2, the ADD/SUB arithmetic unit 11 is toggled, with the result (Reg. B+Reg. C) held in pipeline register 31g via the skip path 41 (shown by a highlighted arrow in FIG. 4), in the second stage S2 as shown in FIG. 4.

Here, a conventional pipeline processor allows pipeline register 31h to hold the result from the MUL arithmetic unit 13, while allowing pipeline register 31e to hold the output from the ADD/SUB arithmetic unit 11. In contrast, based on the determination that “one stage can be skipped”, the output from the ADD/SUB arithmetic unit 11 skips the third stage S3 and is held in pipeline register 31g. Pipeline register 31h holds the result of the calculation performed by the MUL arithmetic unit 13 in response to the executable instruction [PC: n].

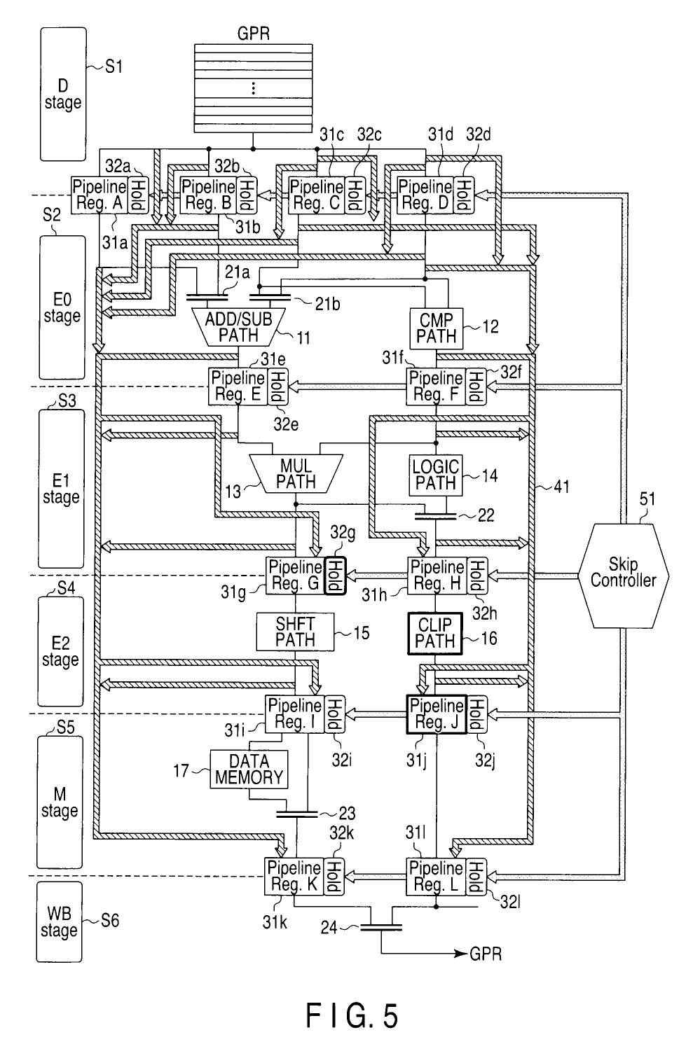

The processing in the next cycle is shown in FIG. 5. FIG. 5 is a block diagram of the processor. As shown in FIG. 5, since the executable instruction [PC: n] is present in the fourth stage S4, the CLIP arithmetic unit 16 is toggled, with the result held in pipeline register 31j, in the fourth stage S4. Furthermore, since the executable instruction [PC: n+1] has already skipped the fourth stage S4, the skip controller 51 allows the hold circuit 32g to continuously hold the hold value of pipeline register 31g.

In the cycle shown in FIG. 5, the conventional pipeline processor writes the result of the calculation performed by the ADD/SUB arithmetic unit 11 in response to the executable instruction [PC: n+1], from pipeline register 31e to pipeline register 31g using the PATH function of the MUL arithmetic unit 13. Thus, the MUL arithmetic unit 13 is toggled to consume power. However, in the pipeline processor according to the present embodiment, in the cycle in FIG. 4, pipeline register 31g has already been skipped by the result of the processing by the ADD/SUB arithmetic unit 11. Thus, the input value from pipeline register 31e to the MUL arithmetic unit 13 remains unchanged. As a result, the MUL arithmetic unit 13 can be inhibited from being toggled, with a reduction in power consumption.

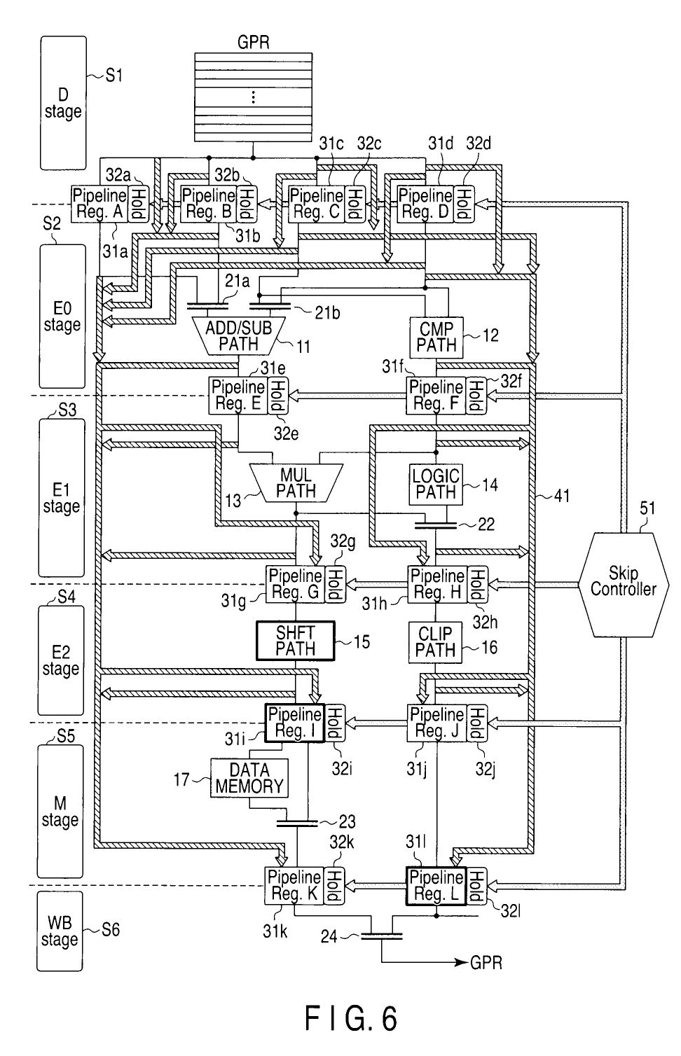

The processing in the next cycle is shown in FIG. 6. FIG. 6 is a block diagram of the processor. As shown in FIG. 6, since the executable instruction [PC: n] is present in the fifth stage S5, pipeline register 31l holds the hold value of pipeline register 31j. Furthermore, since the executable instruction [PC: n+1] is present in the fourth stage S4, the SHFT arithmetic unit 15 is toggled, with the result held in pipeline register 31i, in the fourth stage S4. The cycle shown in FIG. 6 matches the cycle of the conventional pipeline processor, which does not perform skipping. Thus, there is no difference in the operation of the entire pipeline between the conventional pipeline processor and the present pipeline processor.

In the next cycle, since the executable instruction [PC: n] is present in the sixth stage S6, the hold value of pipeline register 31l is written to the general-purpose register GPR in the sixth stage S6. Furthermore, since the executable instruction [PC: n+1] is present in the fifth stage S5, pipeline register 31k holds the hold value of the pipe line register 31i in the fifth stage S5.

In the next (final) cycle, since the executable instruction [PC: n+1] is present in the sixth stage S6, the hold value of pipeline register 31k is written to the general-purpose register GPR in the sixth stage S6.

As described above, in the cycles in FIG. 4, the third stage S3 is skipped, thus enabling a reduction in the toggling of the MUL arithmetic unit 13 and thus in power consumption.

### (2) Double-Stage Skip Operation

Now, the double-stage skip operation will be described. The double-stage skip operation skips two succeeding pipeline stages in the pipeline processor configured as described above. In the present example, execution of an instruction sequence 2 in Table 2 shown below will be described by way of example.

TABLE 2
Instruction sequence

| PC | CODE |
|---|---|
| n | CLIP[MUL{ADD(A, C), D}] |
| n + 1 | SHFT(B) |

Here, in the instruction sequence 2, the operation code of the executable instruction [PC: n] can be interpreted as is the case with the description of the single-stage skip operation given with reference to Table 1. The operation code of the executable instruction [PC: n+1] can be interpreted as follows.
“In the second stage S2, the hold value of pipeline register 31b (Reg. B) is passed through stage S2”; then
“In the second stage S3, the hold value of pipeline register 31e is passed through stage S3”; and then
“In the fourth stage S4, the hold value of pipeline register 31g (Reg. G) is shifted”.

In the pipeline processor, first, the executable instruction [PC: n] (CLIP [MUL {ADD (A, C), D}]) with the smaller PC value is executed. That is, in the first cycle, since the executable instruction [PC: n] is present in the first stage S1, each of pipeline registers 31a, 31c, and 31d holds the output from the pipeline general-purpose register GPR as interstage information, for example, as shown in FIG. 2.

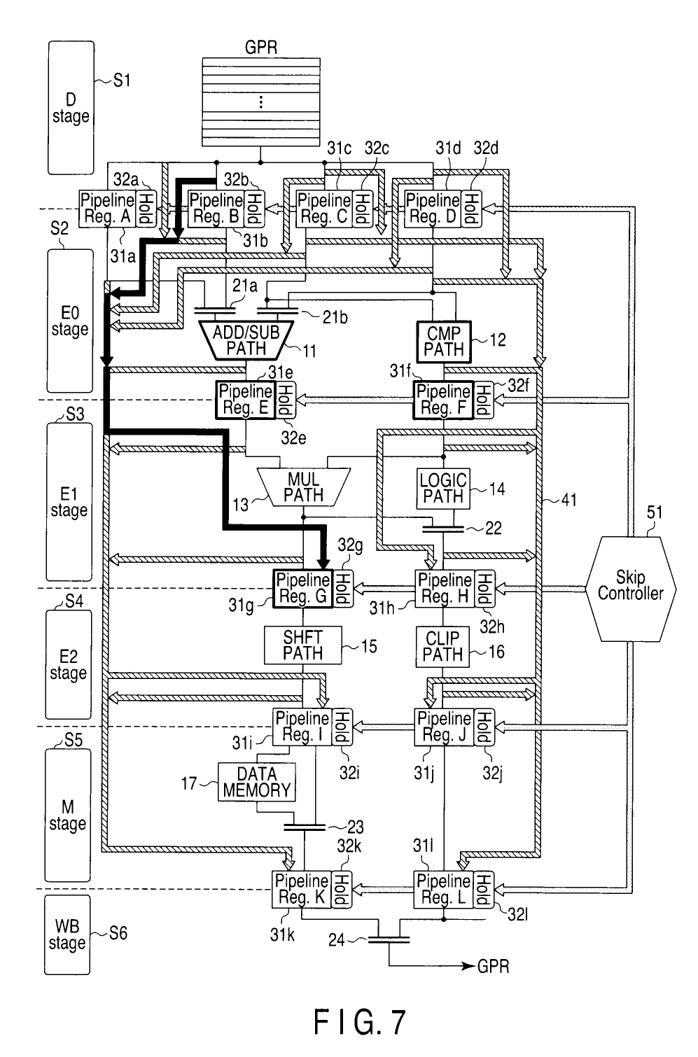

The next cycle is shown in FIG. 7. FIG. 7 is a block diagram of the processor. As shown in FIG. 7, since the executable instruction [PC: n] is present in the second stage S2, the ADD/SUB arithmetic unit 11 and the PATH function of the CMP arithmetic unit 12 are toggled in the second stage S2. Further, pipeline register 31e holds the result of the addition (Reg. A+Reg. C), and pipeline register 31f holds the hold value of pipeline register 31d (the through result from pipeline register 31d). Furthermore, since the executable instruction [PC: n+1] is present in the first stage S1, the skip controller 51 allows pipeline register 31g to acquire, via the skip path 41 (shown by a highlighted arrow in FIG. 7), and hold the output from the pipeline general-purpose register GPR as interstage information in the first stage S1.

Here, the conventional pipeline processor allows pipeline register 31b to hold the value read from the general-purpose register GPR. However, based on determination that two stages can be skipped, the pipeline processor according to the present embodiment allows the output from the general-purpose register GPR to skip the second and third stages and S2 and S3 to be held in pipeline register 31g.

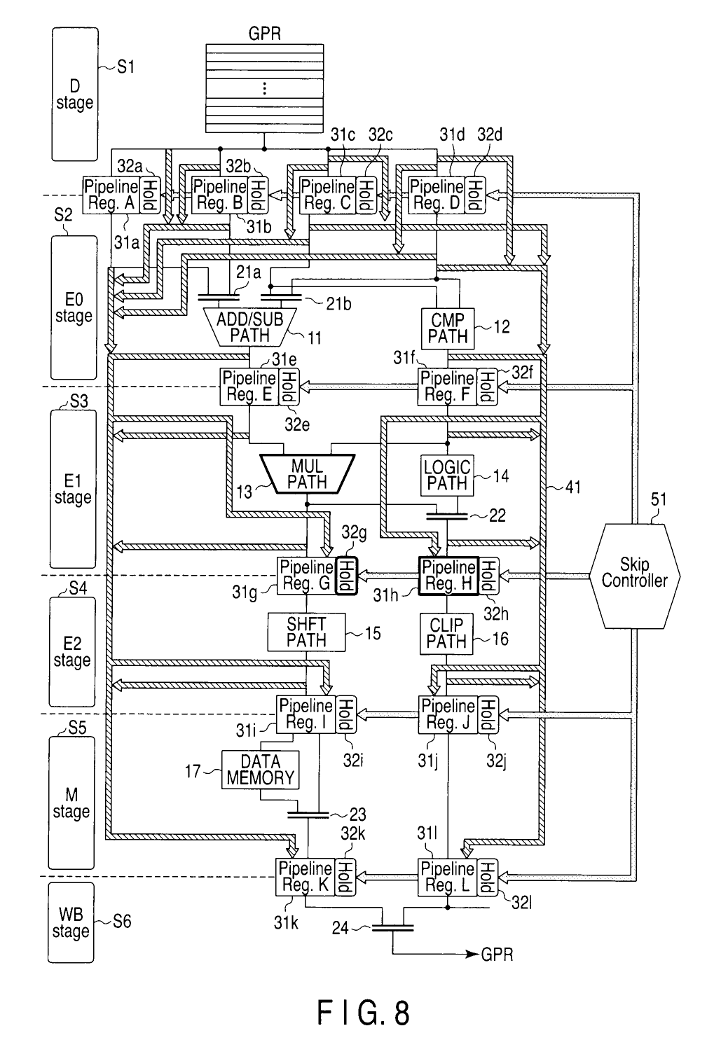

The next cycle is shown in FIG. 8. FIG. 8 is a block diagram of the processor. As shown in FIG. 8, since the executable instruction [PC: n] is present in the third stage S3, the MUL arithmetic unit 13 is toggled in the third stage S3. The pipeline register 31h holds the result of a calculation (Reg. E×Reg. F) by the MUL arithmetic unit 13. Furthermore, since the executable instruction [PC: n+1] has already skipped the fourth stage S4, the skip controller 51 allows the hold circuit 32g to hold the hold value of pipeline register 31g.

The subsequent cycles are similar to the operations in FIGS. 5 and 6 described for the single-stage skip operation.

As described above, in the cycle shown in FIG. 7, the second and third stages S2 and S3 are skipped, thus enabling a reduction in the toggling of the ADD/SUB arithmetic unit 11 and MUL arithmetic unit 13 and thus in power consumption.

(3) Skip after Hold Operation

Now, the skip after hold operation will be described. In the skip after hold operation, if consecutive executable instructions use the same resources (in the present example, the arithmetic unit, the data memory, and the like), before a skip operation, the pipeline preceding the corresponding stage is allowed to hold the interstage information. Then, once the pipeline register preceding the stage with the resources used, the skip operation is performed. In the present example, execution of an instruction sequence 3 in Table 3 will be described by way of example.

TABLE 3
Instruction sequence

| PC | CODE |
|---|---|
| n | SHFT[MUL{ADD(A, C), D)}] |
| n + 1 | SHFT(B) |
| n + 2 | NOP (or instruction that doesn't use |
| | pipeline register 31g) |

In the instruction sequence 3, the meaning of the executable instruction [PC: n] is as follows.
“In the second (E0) stage S2, the hold value of pipeline register 31a (Reg. A) and the hold value of pipeline register 31c (Reg. C) are added together, and the hold value of pipeline register 31d (Reg. D) is passed through the second stage”; then
“In the third (E1) stage S3, the hold value of pipeline register 31e (Reg. E) and the hold value of pipeline register 31f (Reg. F) are multiplied together”; and then
“In the fourth (E2) stage S4, the hold value of pipeline register 31g (Reg. G) is shifted”.

The executable instruction [PC: n+1] is as described with reference to Table 2.

The meaning of the executable instruction [PC: n+2] is “No operation”. However, in the present example, an optional instruction not using pipeline register 31b is permitted to be located.

In the pipeline processor, first, the executable instruction [PC: n] (CLIP [MUL {ADD (A, C), D}]) with the smaller PC value is executed. That is, in the first cycle, since the executable instruction [PC: n] is present in the first stage S1, each of pipeline registers 31a, 31c, and 31d hold the output from the pipeline general-purpose register GPR as interstage information, for example, as shown in FIG. 2.

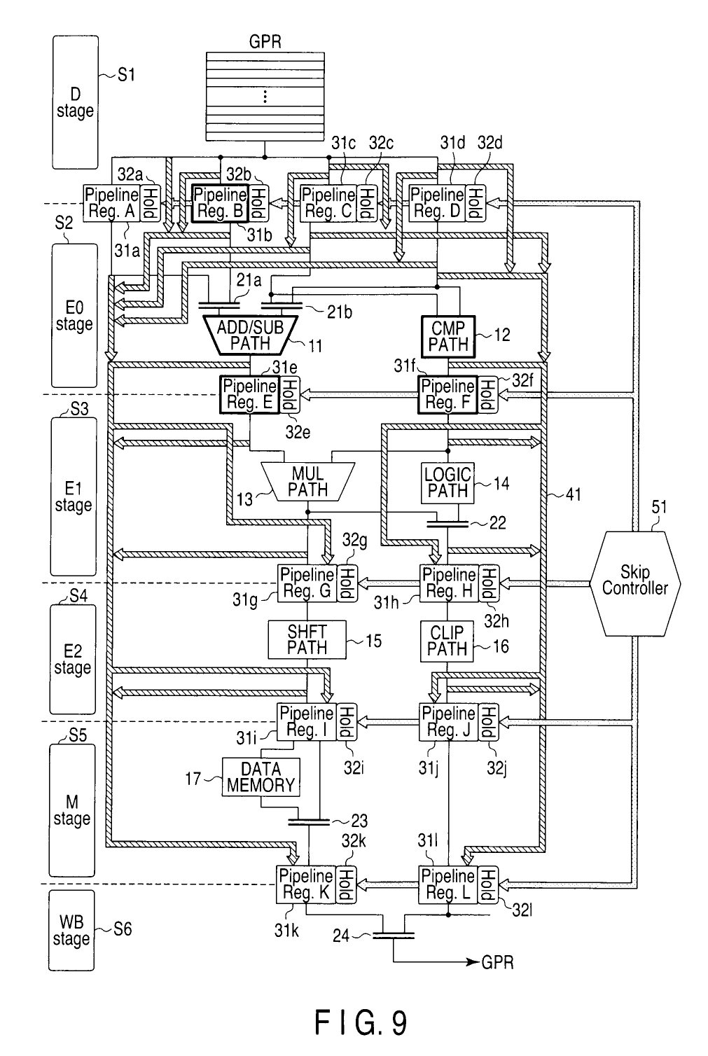

In the next cycle, since the executable instruction [PC: n] is present in the second stage S2, the ADD/SUB arithmetic unit 11 and the PATH function of the CMP arithmetic unit 12 is toggled in the second stage S2, and further pipeline registers 31e holds the result of the addition (Reg. A+Reg. C) and pipeline registers 31f holds the hold value of pipeline register 31d (the through result from pipeline register 31d), respectively, for example, as shown in FIG. 9. Furthermore, since the executable instruction [PC: n+1] is present in the first stage S1, the skip controller 51 allows pipeline register 31b to hold the output from the pipeline general-purpose register GPR in the first stage S1, for example, as shown in FIG. 9.

Here, in the above-described “double-stage skip operation”, the operation of the CLIP arithmetic unit 16 in response to the executable instruction [PC: n] is exclusive to the operation of the SHFT arithmetic unit 15 in response to the executable instruction [PC: n+1], and vice visa. Thus, the skip controller 51 determines that two stages can be skipped.

However, in the present example, the operation of the SHFT operation (arithmetic unit) 15 for the executable instruction [PC: n] overlaps the operation of the SHFT arithmetic unit 15 for the executable instruction [PC: n+1]. Thus, in the cycle shown in FIG. 9, the skip controller 51 determines that no stage can be skipped, and allows pipeline register 31b to hold the output from the general-purpose register GPR.

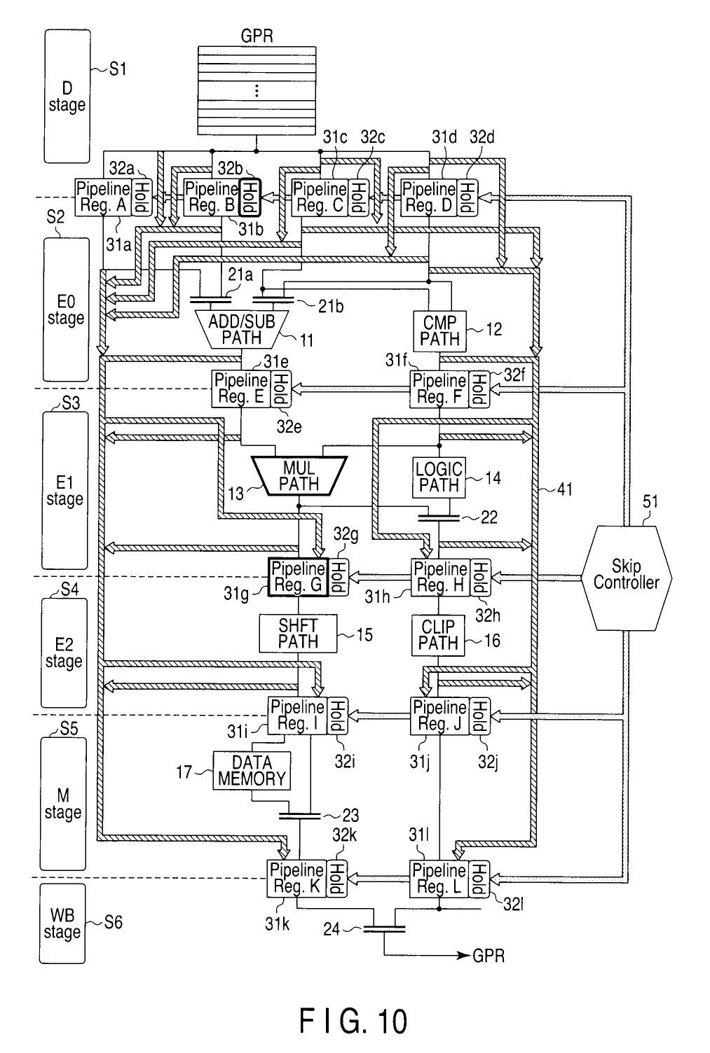

The next cycle is shown in FIG. 10. FIG. 10 is a block diagram of the processor. As shown in FIG. 10, since the executable instruction [PC: n] is present in the third stage S3, the MUL arithmetic unit 13 is toggled and pipeline register 31g holds the result (Reg. E×Reg. F), in the third stage S3. Furthermore, owing to the duplicate operation of the SHFT arithmetic unit 15, the skip controller 51 cannot immediately allow the hold value of pipeline register 31b to skip stages. Thus, based on the determination that the two stages, that is, the second and third stages S2 and S3, can be skipped, a hold circuit 32b holds the hold value of pipeline register 31b until pipeline register 31g preceding stage S4 with the SHFT arithmetic unit 15 is released (until pipeline register 31g is set to a non-use state). At this time, to allow the hold circuit 32b to hold the hold value of pipeline register 31b, the executable instruction [PC: n+2] should be an instruction that does not need writes to pipeline register 31b (the skip controller 51 takes this into account in making the determination).

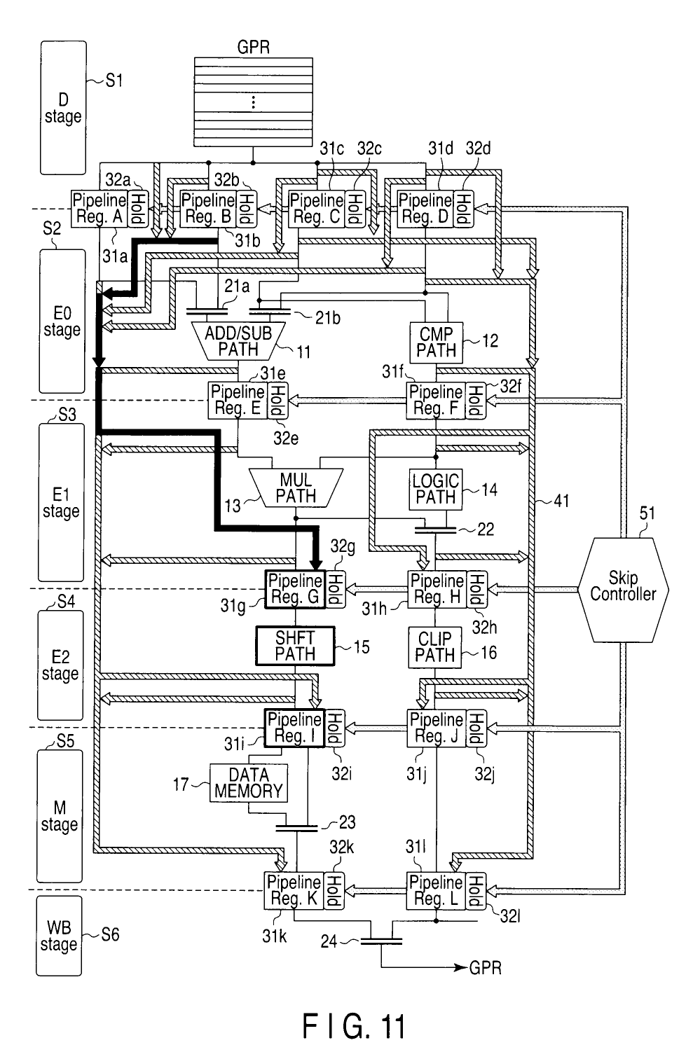

The next cycle is shown in FIG. 11. FIG. 11 is a block diagram of the processor. As shown in FIG. 11, since the executable instruction [PC: n] is present in the fourth stage S4, the SHFT arithmetic unit 15 is toggled and pipeline register 31i holds the result, in the fourth stage S4, for example, as shown in FIG. 11. At this stage, pipeline register 31g is released. Thus, for example, as shown in FIG. 11, the skip controller 51 allows pipeline register 31g to acquire, via the skip path 41 (shown by a highlighted arrow in FIG. 11), and hold the hold value of pipeline register 31b which has been held by the hold circuit 32b.

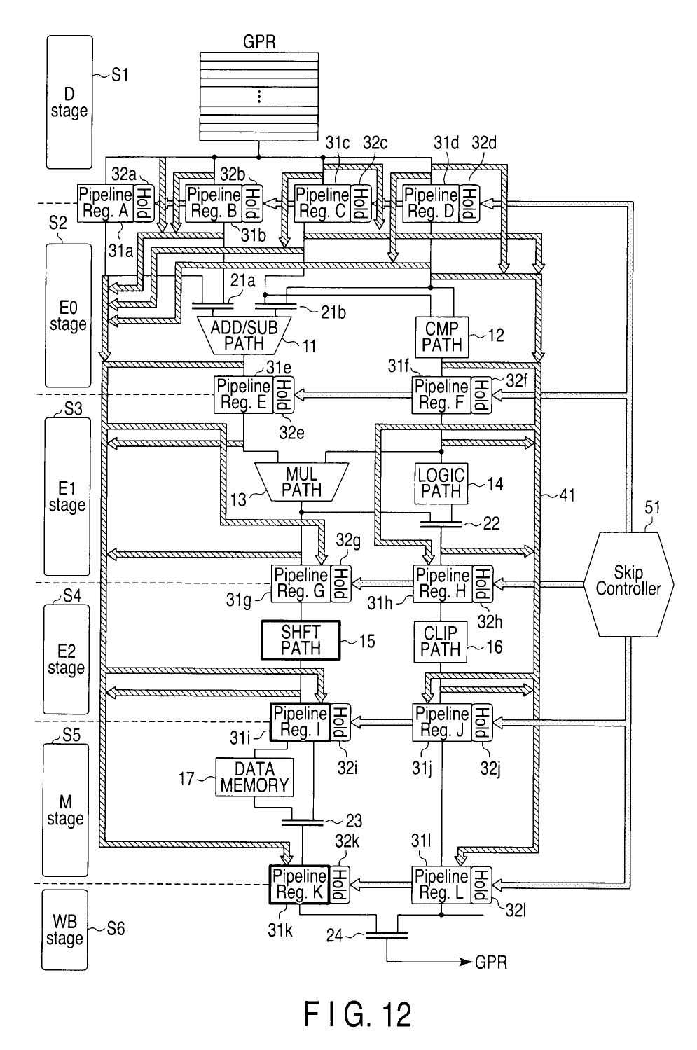

The next cycle is shown in FIG. 12. FIG. 12 is a block diagram of the processor. As shown in FIG. 12, since the executable instruction [PC: n] is present in the fifth stage S5, pipeline register 31k holds the hold value of pipeline register 31i in the fifth stage S5. Furthermore, since the executable instruction [PC: n+1] is present in the fourth stage S4, the SHFT arithmetic unit 15 is toggled and pipeline register 31i holds the result, in the fourth stage S4.

In the next cycle, since the executable instruction [PC: n] is present in the sixth stage S6, the hold value of pipeline register 31k is written to the general-purpose register GPR. Furthermore, since the executable instruction [PC: n+1] is present in the fifth stage S5, pipeline register 31k holds the hold value of pipeline register 31i in the fifth stage S5.

In the next (final) cycle, since the executable instruction [PC: n+1] is present in the sixth stage S6, the hold value of pipeline register 31k is written to the general-purpose register GPR in the sixth stage S6.

As described above, if the consecutive executable instruction [PC: n] and [PC: n+1] use the SHFT arithmetic unit 15, the skip operation is performed once the preceding pipeline register 31g is released. Thus, two stages, that is, the second and third stages S2 and S3, can be skipped. As a result, the ADD/SUB arithmetic unit 11 and the MUL arithmetic unit 13 can be inhibited from being uselessly activated, reducing the power consumption.

In the above-described skip after hold operation, the executable instruction [PC: n+1] stands by in the stage preceding the skip operation. However, in the meantime, the ADD/SUB arithmetic unit 11 in the second stage S2 can continuously use the outputs from pipeline registers 31a, 31c, and 31d with unchanged hold values to reduce the toggling.

(4) Skip with Priority Operation

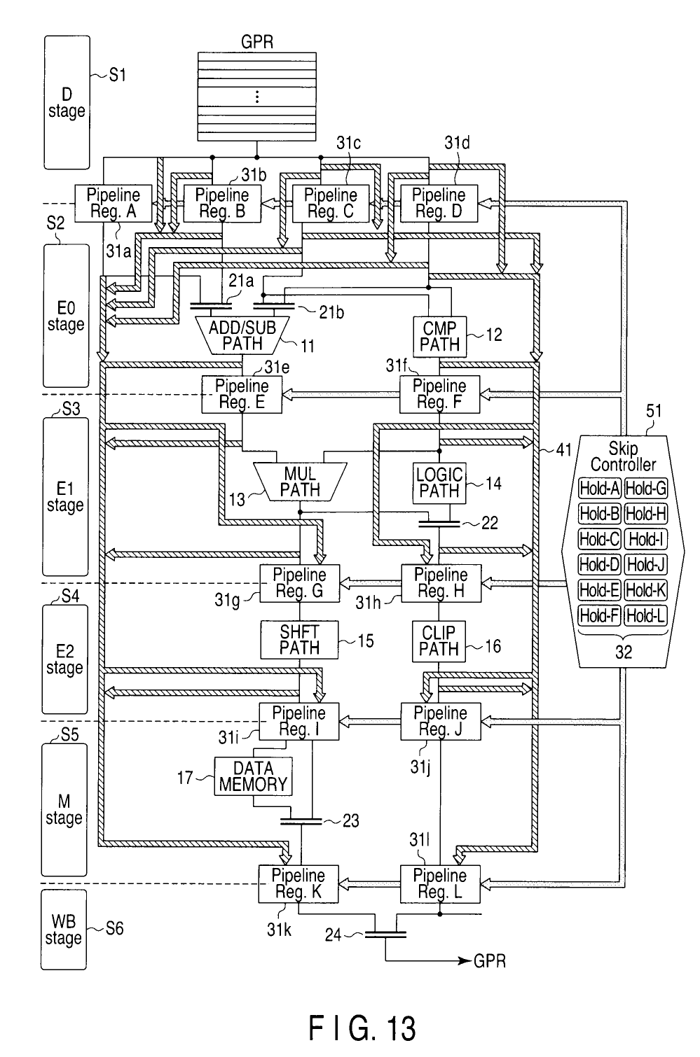

Now, the skip with priority operation will be described. In the above description of the skip operation, the limitation of pipeline registers that can be skipped, the limitation of pipeline stages that can be skipped, and the limitation of the number of executable instructions permitted to perform skipping are not taken into account in any case. When all hardware such as the skip controller, the hold circuit, and the skip path is completely provided, the above-described limitations are not particularly required. On the other hand, if only a part of the hardware can be provided owing to a restriction on the area of the pipeline processor, the restriction results in the need for an operation of selecting one of a plurality of instructions as skip candidates which is to actually perform a skip operation. By way of example, this corresponds to the case where but not all the hold circuits 32 for the respective pipeline registers 31a to 31l pipeline registers can be provided; as shown in the block diagram of the processor in FIG. 13, all the hold circuits 32 can be provided inside the skip controller 51.

If a plurality instructions as skip candidates are present, the skip controller 51 selects one of the instructions which is to perform a skip operation based on the “amount by which the power consumption can be reduced by skipping each pipeline stage”. For example, in the pipeline configuration in FIG. 13, the tendency of the power consumption in stages S1 to S6 is assumed to be such that “the fifth stage S5>the third stage S3>the fourth stage S4” (that is, the data memory 17>the MUL arithmetic unit 13>the SHFT arithmetic unit 15). In this situation, if three instructions are present which can skip the three stages, for example, the third, fourth, and fifth stages S3, S4, and S5, respectively, the skip controller 51 adopts an instruction for skipping of the fifth stage S5 based on the determination that the skip operation can minimize the power consumption of the whole pipeline. That is, the instructions as skip candidates are given priorities according to the amount by which the power consumption can be reduced by the skip operation so that the instruction with the highest priority is executed.

As described above, the skip with priority operation executes one of the plurality of instructions which is most effective for reducing the power consumption, according to the status of the provided hardware and the like.

### [Skip Controller 51]

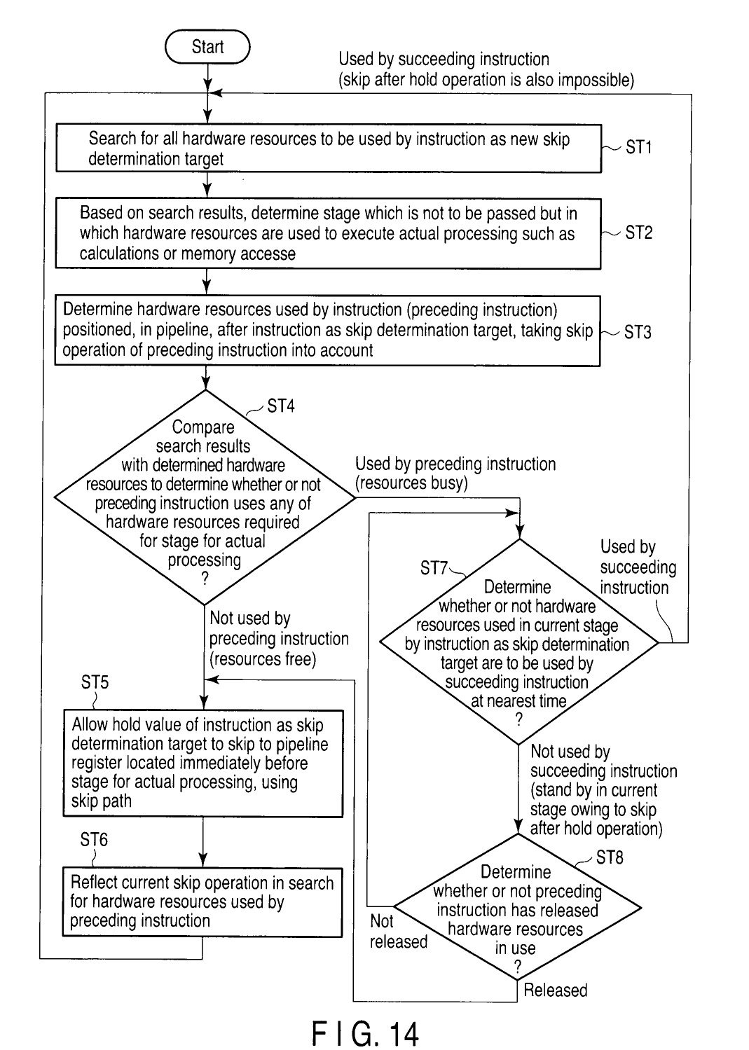

Now, the control by the skip controller 51 during the above-described skip operation will be described. Here, with reference to FIG. 14, a brief description will be given of an operation for determination for hardware resources used by an executable instruction for skip determination (succeeding instruction [PC: n+1]), a preceding executable instruction (preceding instruction [PC: n]), and a succeeding executable instruction (succeeding instruction [PC: n+2]). FIG. 14 is a flowchart of the operation of the skip controller 51.

As shown in FIG. 14, first, in step ST1, the skip controller 51 searches for all the hardware resources used by the succeeding instruction [PC: n+1].

Then, in step ST2, based on the search results in step ST1 described above, the skip controller 51 determines a pipeline stage in which the succeeding instruction [PC: n+1] executes actual processing such as calculations or memory accesses.

Then, in step ST3, the skip controller 51 determines hardware resources used by the preceding instruction [PC: n], positioned in the pipeline stage after the succeeding instruction [PC: n+1], taking the skip operation of the preceding instruction [PC: n] into account.

Then, in step ST4, the skip controller 51 compares all the hardware resources searched for in step ST1 described above and used by the succeeding instruction [PC: n+1] with all the hardware resources used by the preceding instruction [PC: n] determined in step ST3 described above. The skip controller 51 thus determines whether or not the preceding instruction [PC: n] determined in step ST3 described above uses the hardware resources in the stage determined in step ST2 described above.

Then, upon determining, in step ST4 described above, that the preceding instruction [PC: n] does not use the hardware resources used by the succeeding instruction [PC: n+1], the skip controller 51 allows, in step ST5, the hold value of the succeeding instruction [PC: n+1] to skip to the pipeline register located immediately before the stage for actual processing, using the skip path 41.

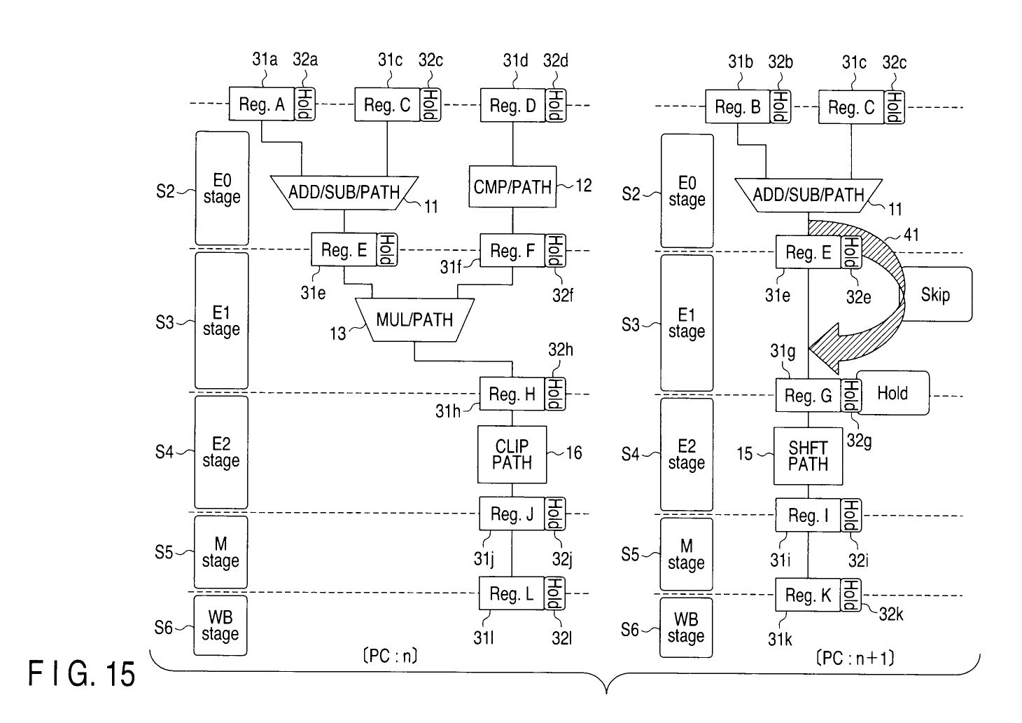

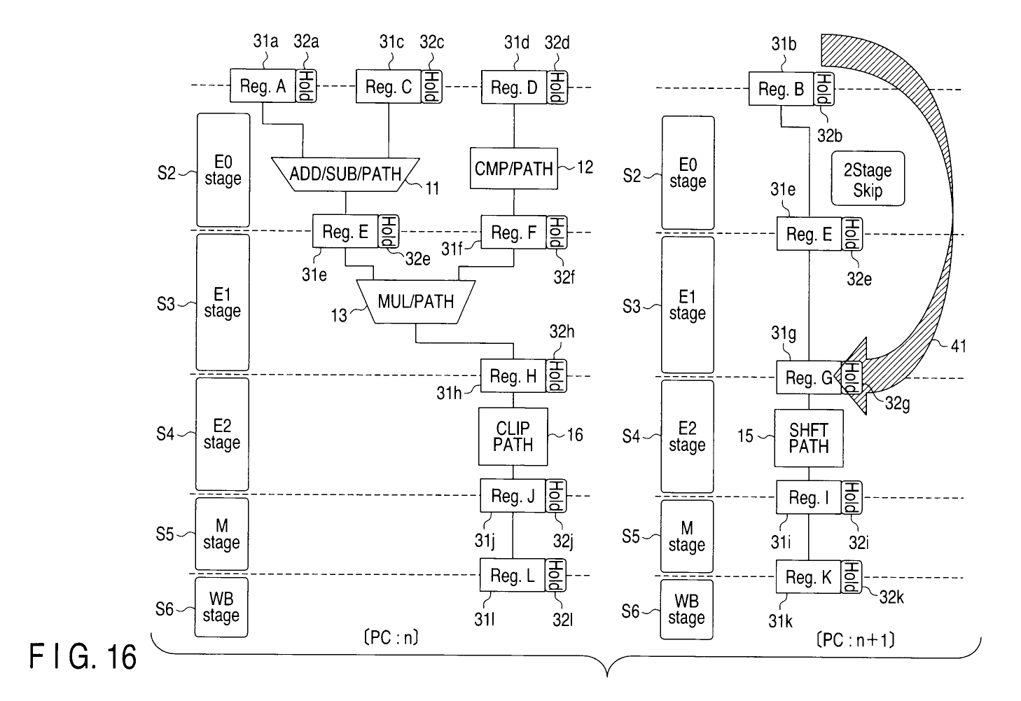

This corresponds to the above described single- or double-stage skip operation. FIGS. 15 and 16 illustrate a configuration showing processing blocks required for the operations shown in Tables 1 and 2, for each instruction sequence. FIG. 15 corresponds to Table 1. FIG. 16 corresponds to Table 2. In either case, the preceding instruction [PC: n] does not uses the SHFT arithmetic unit 15. However, the succeeding instruction [PC: n+1] uses the SHFT arithmetic unit 15. Thus, for the succeeding instruction [PC: n+1], input data to the arithmetic unit 15 is allowed to skip to the register 31g.

Then, in step ST6, the skip controller 51 to allow the current skip operation to be reflected to allow determination of the hardware resources used by the preceding instruction [PC: n] in step ST3 described above.

On the other hand, in step ST4 described above, if the preceding instruction [PC: n] is determined to use the hardware resources used by the succeeding instruction [PC: n+1], then in step ST7, the skip controller 51 determines whether or not the hardware resources used by the succeeding instruction [PC: n+1] in the current stage are to be further used by the succeeding instruction [PC: n+2] at the nearest time.

Upon determining, in step ST7 described above, that the hardware resources are to be used by the succeeding instruction [PC: n+2], the skip controller 51 determines that the skip operation is impossible, and repeats the above-described processing starting with step ST1.

On the other hand, upon determining, in step ST7 described above, that the hardware resources are not to be used by the succeeding instruction [PC: n+2], the skip controller 51 determines whether or not the hardware resources determined in step ST2 described above have been released by the preceding instruction [PC: n]. The skip controller 51 repeats the processing in steps ST7 and ST8 described above until the hardware resources are released. The skip controller 51 further allows the hold circuit for the pipeline register located several stages before the stage for actual processing to hold the hold value of the succeeding instruction [PC: n+1].

Then, when the hardware resources are released, then in step ST5, the skip controller 51 allows the hold value of the succeeding instruction [PC: n+1] to skip to the pipeline register located immediately before the stage for actual processing, using the skip path 41.

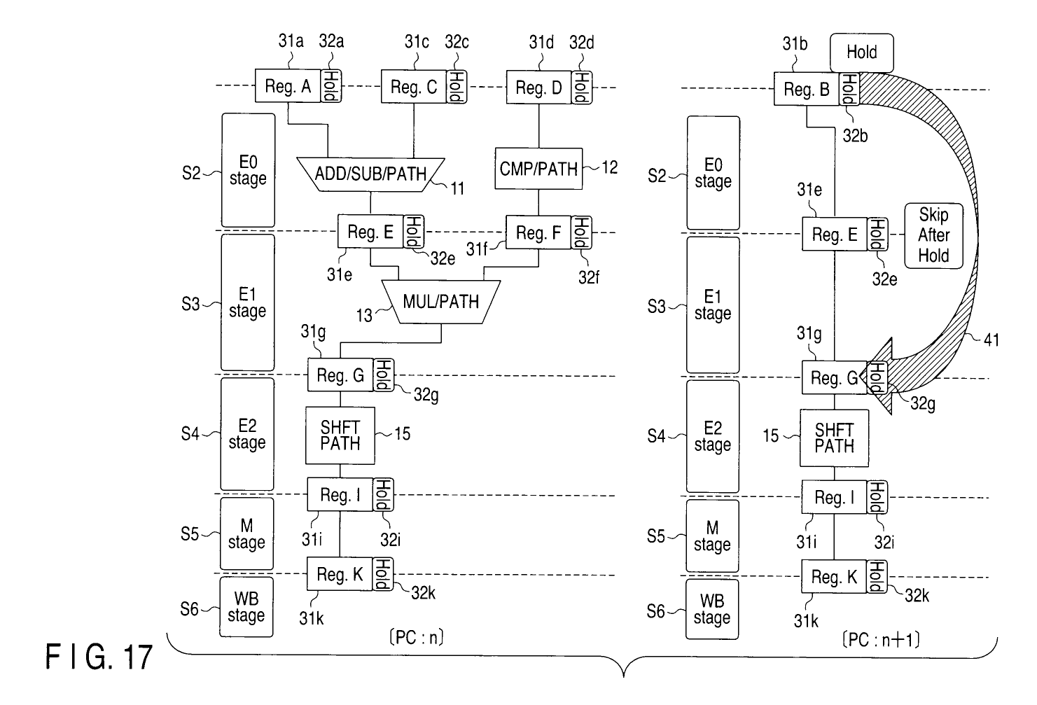

This corresponds to the above-described skip after hold operation. FIG. 17 shows a configuration showing processing blocks required for the operation shown in Table 3, for each instruction sequence. In this case, both the preceding instruction [PC: n] and the succeeding instruction [PC: n+1] use the SHFT arithmetic unit 15. Thus, after the SHFT operation on the preceding instruction [PC: n] is finished, data on the preceding instruction [PC: n] to be input to the SHFT arithmetic unit 15 is allowed to skip to the register 31g.

As described above, the skip controller 51 can determine whether or not the executable instruction as a processing target requires processing in the succeeding pipeline stage, to skip the unwanted stage. This allows possible wasteful power consumption in the skipped stage to be reduced.

As described above, in an in-order pipeline processor executing instructions through a pipeline operation, the toggling of resources in pipeline stages with unnecessary processing is reduced. Thus, extra power consumption is reduced. That is, the pipeline processor allows stages including unnecessary processing to be skipped based on the determination by the skip controller monitoring to check whether or not the executable instruction as a processing target requires processing in the succeeding pipeline stage. Thus, the toggling of the resources in the stage with unnecessary processing can be reduced. Consequently, extra power consumption in the stage with unnecessary processing can be reduced without the need for a special instruction such as a skip instruction.

The above-described embodiment should be broadly interpreted as an example and is not intended to limit the present invention. That is, the present invention is applicable not only to pipeline processors with various numbers of stages but also to pipeline processors having hardware resources which are different from or are arranged differently from those in the present embodiment. For example, the skip path 41 is not limited to the one shown in FIGS. 1 and 13 but may be arranged in various manners. By way of example, the skip path may be arranged so as to allow the output from the ADD/SUB arithmetic unit 11 in the second stage S2 to skip to pipeline register 31h. Furthermore, the number of skipped pipeline stages may be at least two.

Additionally, the instruction sequence executed by the pipeline processor through the pipeline operation is not limited to the one in the embodiment.

A processor system according to the present embodiment includes:

a plurality of pipeline stages S1 to S6 in which an executable instruction is subjected to pipeline processing;

a transfer path 41 along which data can be transferred so as to bypass any of the pipeline stages; and

a controller 51 allowing the i-th (i is a natural number greater than or equal to 1) executable instruction to skip processing in the j-th (j is a natural number greater than or equal to 1) pipeline stage if the i-th executable instruction does not require processing in the j-th pipeline stage (see FIG. 4).

Furthermore, in the processor system,

if processing in the (j+1)-th (PC (n+1)) pipeline stage S1 to S6 executed by the (i−1)-th (PC (n)) executable instruction is different from processing in the (j+1)-th (PC (n+1)) pipeline stage S1 to S6 executed by the i-th executable instruction, the controller 51 allows the i-th executable instruction to skip the j-th pipeline stage S1 to S6.

A method for subjecting an executable instruction to pipeline processing according to the present embodiment includes:

determining that the i-th (i is a natural number greater than or equal to 1) executable instruction does not use the hardware resources in the j-th (j is a natural number greater than or equal to 1) pipeline stage S1 to S6 but uses the hardware resources in the (j+1)-th pipeline stage;

determining whether or not the (i−1)-th executable instruction uses any of those of the hardware resources in the (j+1)-th pipeline stage which are to be used by the i-th executable instruction; and

if the (i−1)-th executable instruction is determined not to use any of those of the hardware resources in the (j+1)-th pipeline stage which are to be used by the i-th executable instruction, allowing the i-th executable instruction to skip processing in the j-th pipeline stage.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A processor system comprising:
a plurality of pipeline stages in which an instruction sequence comprising a plurality of executable instructions is subjected to processing;
a controller determining whether or not each of the executable instructions to be processed in the pipeline stages requires processing in a succeeding pipeline stage; and
a transfer path which, if the controller determines that each of the executable instructions does not require the processing in the succeeding pipeline stage, skips one of the pipeline stages including the unnecessary processing.

2. The system according to claim 1,
wherein a pipeline register is provided between the plurality of pipeline stages to hold interstage information for each of the executable instructions subjected to pipeline processing in each of the stages.

3. The system according to claim 1,
wherein if the number of pipeline stages with processing not required for one of the executable instructions is at least two, the controller allows one of the executable instructions to skip the at least two pipeline stages each including the unnecessary processing, at a time.

4. The system according to claim 1,
wherein if a plurality of executable instructions are present in the instruction sequence which do not require the processing in the succeeding pipeline stage, the controller preferentially allows an executable instruction not requiring processing in a pipeline stage with highest power consumption to skip the processing.

5. The system according to claim 1, further comprising a hold circuit holding interstage information subjected to pipeline processing in each of the pipeline stages,
wherein if a succeeding executable instruction fails to pass a preceding executable instruction, the controller allows the hold circuit to internally hold interstage information for the succeeding executable instruction until the preceding executable instruction passes through one of the pipeline stage to be skipped by the succeeding executable instruction, and
after the preceding executable instruction passes through the pipeline stage, the controller allows the succeeding executable instruction to skip the pipeline stage via the transfer path.

6. The system according to claim 5, wherein the hold circuit is allowed to internally hold the interstage information for the succeeding executable instruction if the preceding executable instruction overlaps the succeeding executable instruction.

7. A processor system comprising:
a plurality of pipeline stages in which an executable instruction is subjected to processing;
a transfer path along which data is transferred so as to bypass any of the pipeline stages; and
a controller allowing an i-th (i is a natural number greater than or equal to 1) executable instruction to skip processing in a j-th (j is a natural number greater than or equal to 1) pipeline stage if the i-th executable instruction does not require processing in the j-th pipeline stage.

8. The system according to claim 7,
wherein if processing in a (j+1)-th pipeline stage executed by an (i−1)-th executable instruction is different from processing in the (j+1)-th pipeline stage executed by the i-th executable instruction, the controller allows the i-th executable instruction to skip the j-th pipeline stage.

9. The system according to claim 7,
wherein the j-th pipeline stage includes a plurality of pipeline stages.

10. The system according to claim 7,
wherein if the (i−1)-th executable instruction requires the processing in the (j+1)-th pipeline stage, the controller allows the i-th executable instruction to skip the j-th pipeline stage after the (i−1)-th executable instruction has completed the processing in the (j+1)-th pipeline stage.

11. The system according to claim 10, further comprising a register provided between consecutive pipeline stages and connecting to hold data; and
a hold circuit retaining the data by not performing writes to the register.

12. The system according to claim 11,
wherein if the (i−1)-th executable instruction requires the processing in the (j+1)-th pipeline stage,
the controller instructs any of the hold circuits to continue holding data for the i-th executable instruction in any of the registers until the (i−1)-th executable instruction has completed the processing in the (j+1)-th pipeline stage.

13. The system according to claim 7,
wherein if a plurality of the executable instructions successfully skip the pipeline stage, the controller preferentially allows an executable instruction not requiring processing in a pipeline stage with highest power consumption to skip the pipeline stage.

14. The system according to claim 7,
wherein a processing executed by the executable instruction is at least one of an addition, a subtraction, a comparison, a multiplication, a shift operation, a clip operation, data holding, and logical operation.

15. A method for subjecting an executable instruction to pipeline processing, the method comprising:
determining that an i-th (i is a natural number greater than or equal to 1) executable instruction does not use hardware resources in a j-th (j is a natural number greater than or equal to 1) pipeline stage but uses hardware resources in a (j+1)-th pipeline stage;
determining whether or not a (i−1)-th executable instruction uses any of those of the hardware resources in the (j+1)-th pipeline stage which are to be used by the i-th executable instruction; and
if the (i−1)-th executable instruction is determined not to use any of those of the hardware resources in the (j+1)-th pipeline stages which are to be used by the i-th executable instruction, allowing the i-th executable instruction to skip processing in the j-th pipeline stage.

16. The method according to claim 15,
wherein the i-th executable instruction does not use the hardware resources in the (j−1)-th pipeline stage, not only the processing in the j-th pipeline stage but also the processing in the (j−1)-th pipeline stage is skipped.

17. The method according to claim 15, further comprising, if the (i−1)-th executable instruction is determined to use any of the hardware resources in the (j+1)-th pipeline stage, allowing any of the registers to hold data for the (i−1)-th executable instruction; and
after the (i−1)-th executable instruction completes using the hardware resource in the (j+1)-th pipeline stage, introducing data for the i-th executable instruction into the (j+1)-th pipeline stage.

18. The method according to claim 15,
wherein the processing executed by the executable instruction includes at least one of an addition, a subtraction, a comparison, a multiplication, a shift operation, a clip operation, data holding, and logical operation.

19. The method according to claim 15,
wherein if a plurality of the executable instructions successfully skip the pipeline stage, an executable instruction not requiring processing in the pipeline stage with highest power consumption is allowed to skip the pipeline stage.

20. The method according to claim 17,
wherein the data for the i-th executable instruction is held in the (j−1)-th pipeline stage until the (i−1)-th executable instruction completes using the hardware resource.
